(19) United States
(12) Patent Application Publication
(10) Pub. No.: US 2014/0061008 A1
(43) Pub. Date: Mar. 6, 2014

(54) Food Transport Belt

(71) Applicant: James Haythornthwaite, Hudson (CA)

(72) Inventor: James Haythornthwaite, Hudson (CA)

(21) Appl. No.: 14/079,817

(22) Filed: Nov. 14, 2013

Related U.S. Application Data
(63) Continuation-in-part of application No. 13/596,504, filed on Aug. 28, 2012.

(51) Int. Cl. B65G 15/34; B29C 39/02

(52) U.S. Cl. CPC B65G 15/34; B29C 39/025
USPC 198/844.1; 264/255

(57) ABSTRACT

A transport belt for a food processing machine and a manufacturing method thereof is provided. The transport belt comprising a first portion comprising a first elastomeric material having a first durometer of hardness; and a second portion comprising a second elastomeric material having a second durometer of hardness. The first durometer of hardness is different than the second durometer of hardness. The first portion provides a surface for food materials to be processed.

### CROSS-REFERENCE TO RELATED APPLICATIONS

This application is a continuation-in-part of application Ser. No 13/596,504, filed on Aug. 28, 2012, entitled “FOOD TRANSPORT BELT” now pending, which claims priority from Canadian Application 2,750,750, filed on Aug. 29, 2011, entitled “FOOD TRANSPORT BELT” by James Haythornthwaite, the entire disclosures of which applications are hereby incorporated by reference for all purposes as if fully set forth herein.

### FIELD OF THE INVENTION

The present invention relates to a food transport belt and manufacturing method thereof, more specifically, the present invention relates to a multiple durometers of hardness food transport belt and manufacturing method thereof.

### BACKGROUND OF THE INVENTION

In the food processing industry it is common to use a so-called soft separator which separates soft and solid components of food, for example, bones from meat. Such food separator has been described for example in U.S. Pat. No. 4,899,890. In the soft separator, a compression belt pushes food against a perforated drum for the purpose of removing some unwanted ingredient, such as the skins from the edible starchy portion of potatoes, meat from bones, or as in the fish industry, the removal of fish meat from fish bones.

Referring to FIG. 1, the soft separator 100 generally has a machine frame 102 supporting a hollow drum 104 driven to rotate and having a perforated outer surface 106, an endless compression or transport belt 108 which is adapted to apply pressure onto the hollow drum 104 from outside on being wrapped around a portion of the circumference of the hollow drum 104.

The function of the machine is such that the material to be compressed is placed between the compression belt 108 and the perforated outer surface 106 of the hollow drum 104 and is thereby subjected to a quasi-hydraulic pressure. This pressure causes the more readily flowable soft components of the material mixture to flow through the perforations of the hollow drum 104, while the remaining components are left on the outer food transport belt and are stripped away from there. A stripping blade 110, which may be positioned with its cutting edge directed against the direction of rotation of the hollow drum 104 and pressed against the outer drum surface may be used. Conventional means, for example but not limited to, a stationary auger (not shown), may be provided for removing material from the interior 112.

With a soft separator, a variety of materials may be subjected to a separating process which involves the division of components of varying flowability. The process is continuous and generally high yielding. One common applied separation is the separation of bone from meat. The meat bones 114 are positioned and fed to the hollow drum 104 via a chute or conveying belt before being carried to the perforated outer surface 106 with the transport belt 108.

The transport belt is generally made with a uniform material, for example, urethane, and is known in the art as a single durometer belt.

The term “durometer” is used to described the measurement of hardness in polymers, elastomers and rubbers.

The two most common durometer scales, using slightly different measurement systems, are the ASTM D2240 type A and type D scales. The A scale is for softer plastics, while the D scale is for harder ones. Each scale results in a value between 0 and 100, with 0 being the softest and 100 being the hardest. Generally, the durometer used for a transport belt for meat processing is from about 70 to about 90, Shore A

A single durometer belt may be not suitable for different types of the meat products being processed, e.g. beef, pork, poultry, fish. Each meat product has a different texture including fibre length. When the compression belt is used for any substantial length of time, the sharp edges of the bone particles gradually begin to cut into the surface of the rubber belt, frequently causing shreds to separate from the compression belt and enter into the agglomeration of the meat mass, frequently pressing the shreds of belt along with the purer meat particles through the drum during the separating process.

More significantly, where the category of animals from which the crushed meat, that is, meat including both meat and bone particles, derives from the red meat field, such as beef from cattle, ham or pork from pigs, lamb from sheep, and so forth, the bone structure of such animals is generally more calcareous and of greater size. As a result, these sharper bone particles have a tendency to immediately commence cutting and shredding of the transport and compression belt upon initiation of the meat separating process.

The single durometer belt may also not be suitable for different hole sizes on the perforated outer surface 106 on the hollow drum 104.

Further, a higher durometer belt which is needed for higher density meat such as beef may have lower friction, resulting in less grip with the drive system.

The knurled surface ??? of the existing transport belts is not constructed to effect a retention of the meat. During the operation, the meat material may become wasted due to its being squeezed laterally from the belt.

Still further, the transport belt may wear faster at the center than at the edges of the conveyor belt. This differential in the transport belt wear is due to a greater loading of the meat material including bones at the center of the belt than at the edges of the belt, such that the center of the belt carries a larger portion of the weight of the meat to be processed than do the edges of the belt.

Therefore, there is a transport belt which has multiple durometers in different portions of the belt.

### SUMMARY OF THE INVENTION

In accordance with one embodiment of the present invention, there is provided a transport belt for a food processing machine, the transport belt comprising: a first portion providing a surface for food materials to be processed, the first portion comprising a first elastomeric material having a first durometer of hardness; and a second portion comprising a second elastomeric material having a second durometer of hardness; wherein the first durometer of hardness is different than the second durometer of hardness.

In some embodiments, the transport belt further comprises a reinforcement material.

In some embodiments, the reinforcement material is located between the first portion and the second portion.

In some embodiments, the first durometer of hardness is higher than the second durometer of hardness.

In some embodiments, the first elastomeric material or the second elastomeric material is polyurethane elastomer.

In some embodiments, the first portion provides a ridging or a knurling.

In some embodiments, the first durometer of hardness is from about 70 to about 90 Shore A, preferably, from about 75 to about 85 Shore A, more preferably, about 80 Shore A.

In some embodiments, the second durometer of hardness is from about 50 to about 70 Shore A, preferably, from about 55 to about 65 Shore A, more preferably, about 60 Shore A.

In some embodiments, the second elastomeric material with the second durometer of hardness provides a better friction to a drive of the food processing machine.

In some embodiments, the reinforcement material is tensile-stress-bearing.

In some embodiments, the reinforcement material is selected from the group consisting of: canvas, crimped fabric, leno weave, and knit.

In some embodiments, the reinforcement material is made of any desired fiber selected from the group consisting of: aramid, nylon, polyester, rayon, Kynar, polypropylene, cotton and a combination thereof.

In some embodiments, the first region has a greater thickness in a center than on an edge of the transport belt.

In accordance with another aspect of the invention, there is provided a method for producing a transport belt for a food processing machine, the method comprising the steps of: providing a mould comprising an inner casing and a first outer casing; casting a first elastomeric material having a first durometer of hardness in to the mould; removing the first outer casing; providing a second outer casing in concentric relationship to the inner casing, the second outer casing having a greater diameter than a diameter of the first outer casing; and casting a second elastomeric material having a second durometer of hardness in to the mould.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 depicts an existing soft food separator with solid food component;

FIG. 2 is a cross-sectional view of the hollow drum and the transport belt of the soft food separator;

FIGS. 3 (a), (b) and (c) are cross-sectional views of embodiments of the present invention, taken generally along line III-III of FIG. 2;

FIG. 4 shows steps of an exemplary method for producing the transport belt of the present invention;

FIG. 5 illustrates the casting of the transport belt of the present invention; and

FIG. 6 shows steps of an exemplary method for producing the transport belt of the present invention;

FIG. 7 illustrates the casting of the transport belt of the present invention.

### DETAILED DESCRIPTION OF PREFERRED EMBODIMENTS

Reference will now be made in detail to some specific embodiments of the invention including the best modes contemplated by the inventor for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well-known process operations have not been described in detail in order not to unnecessarily obscure the present invention.

In this specification and the appended claims, the singular forms “a,” “an,” and “the” include plural references unless the context clearly dictates otherwise. Unless defined otherwise, all technical and scientific terms used herein have the same meaning as commonly understood to one of ordinary skill in the art to which this invention belongs.

The term “durometer” is intended to refer to the measurement of hardness in polymers, elastomers and rubbers. The two most common durometer scales, using slightly different measurement systems, are the ASTM D2240 type A and type D scales. The A scale is for softer plastics, while the D scale is for harder ones. Each scale results in a value between 0 and 100, with 0 being the softest and 100 being the hardest.

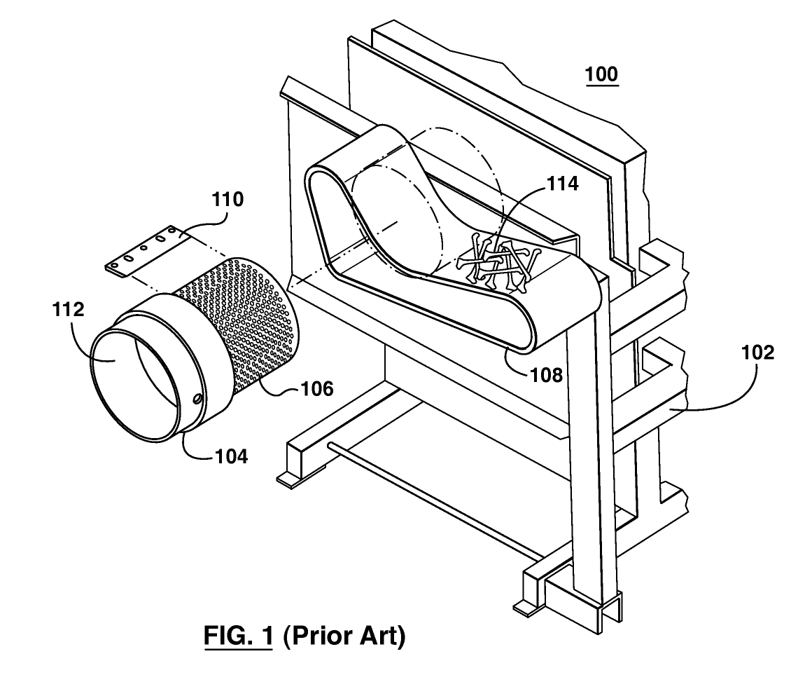

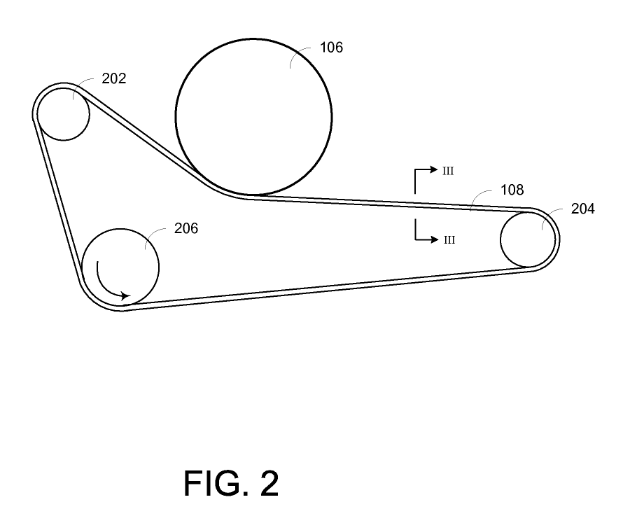

FIG. 2 is a cross-sectional view of the transport belt of the soft food separator as depicted in FIG. 1.

In order to support the transport belt 108, there is provided two belt rollers 202, 204 and a belt drive 206, arranged so that the transport belt 108 can be removed and replaced or cleaned as is necessary. The belt rollers 202, 204 are so spaced in relation to the hollow drum 104 so that the transport belt 108 engages in a compressing relationship to the hollow drum 104.

The belt drive 206 is arranged so that it is both driven by means of the drive mechanism (not shown), and is at the same time in a tensioning position so as to permit tensioning of the transport belt 108.

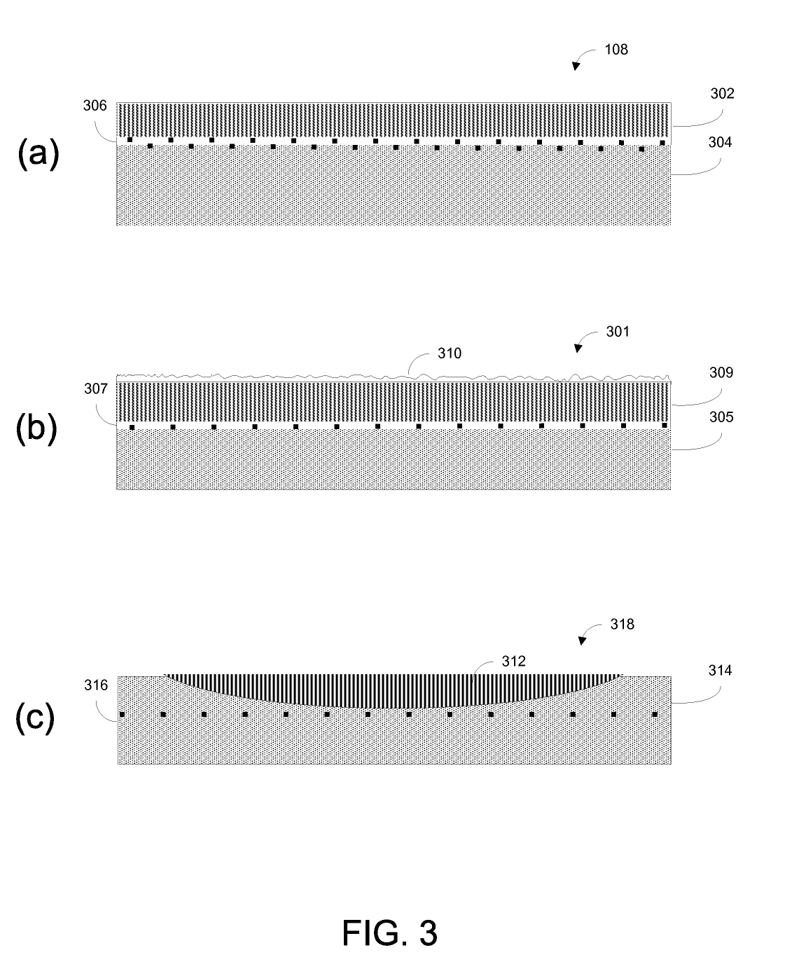

FIGS. 3(a), (b) and (c) are cross-sectional views, taken generally along line III-III of FIG. 2.

In accordance with one embodiment of the present invention, there is provided a transport belt with multiple durometers. Preferably, the transport belt 108 comprises a first portion or lower portion as illustrated with a first durometer, and a second portion or an upper portion as illustrated with a second durometer.

Referring to FIG. 3(a), the exemplary transport belt preferably includes an upper portion 302, and a lower portion 304, where the upper portion 302 provides a surface for the food material to be processed. The upper portion 302 has a durometer of hardness different than the durometer of hardness of the lower portion 304. Preferably, the upper portion 302 comprises a resilient elastomeric material having a durometer of hardness that may be harder or softer than the durometer of hardness of the lower portion 304. The upper portion and the lower portion can have different thickness. In some embodiments, the upper portion and the lower portion may have same thickness.

In one embodiment, the upper portion 302 has a durometer of hardness greater than that of the lower portion 304. In preferred embodiments of the present invention, the upper portion 302 has a durometer of hardness of from about 70 to about 90 Shore A, preferably, from about 75 to about 85 Shore A, more preferably, about 80 Shore A, with the lower portion 304 having a durometer of hardness of from about 50 to about 70 Shore A, preferably, from about 55 to about 65 Shore A, more preferably, about 60 Shore A. Since the lower portion 304 makes contact with the belt rollers 202, 204 and the belt drive 206, the lower portion 304 preferably presents a relatively high friction surface which helps to prevent slippage between the belt and the drive roll.

In some embodiments, the transport belt 108 with different durometers of hardness may be used to compensate for different types of products, e.g. beef, pork, poultry, fish, etc., as each product has a different texture including fibre length.

The transport belt 108 with different durometers of hardness may also be used to compensate the different hole sizes on the hollow drum 104.

The transport belt 108 may be made of any desired material which includes, by way of example, urethanes such as of the liquid cast or millable gum variety; and thermoplastic such as polyester, and blends thereof. Preferably, the transport belt 108 may be made of resilient elastomeric material. Preferably, the transport belt 108 may be made of polyurethane elastomer.

Preferably, the transport belt 108 may have a reinforcement material 306. Preferably, the reinforcement material may be tensile-stressbearing. The reinforcement material 306 may be a non-woven fabric, a twined fabric, a woven fabric, a knit fabric or a single plied yarns.

The reinforcement material 306 may be of any suitable fabric such as canvas, crimped fabric, leno weave, knit or the like; and made of any desired fiber including aramid, nylon, polyester, rayon, Kynar®, polypropylene and cotton. Preferably, the reinforcement material is woven or single plied yarns wrapped peripherally. The reinforcement material 306 may comprise one single layer of fabric or yarn or may comprise a plurality of layers as illustrated in FIG. 3(a).

Referring to FIG. 3 (b), the upper portion 308 is generally provided with some degree of roughness, such as through ridging, or by knurling 310, so that sufficient frictional engagement of the belt with the meat-bearing material will result during operation of the apparatus causing an effective transfer of said material into a compressive relationship with the surface of the drum. The upper portion 308 with a higher durometer of hardness may advantageously allow a stronger ridging or knurling and reduce bone penetration. The reinforcement material 307 has a single layer of fabric or yarn. In the embodiment shown in FIG. 3(b), the ratio of the thickness of the upper portion 309 to the thickness of the lower portion 305 is different than the ratio of the thickness of the upper portion 302 to the thickness of the lower portion 304 in the embodiment illustrated in FIG. 3(a).

The upper portion of the transport belt 108 may have shapes other than the rectangle shape as illustrated in FIGS. 3(a) and 3(b). Referring to FIG. 3(c), in accordance with another embodiment of the present invention, the durometer of hardness of the upper portion 312 may decrease as from the center to the edge, the upper portion 312 has an arc shape with a higher durometer of hardness as illustrated in the cross-section. In this embodiment, the optional reinforcement material 316 may be embedded in the lower portion 314 of the transport belt 318. This embodiment provides a solution to the problem that the transport belt wears faster at the center of the conveyor belt than at the edges of the conveyor belt, due to a greater loading of the meat material including bones at the center of the transport belt 318.

The transport belt with multiple durometers of the present invention may be manufactured by known manufacturing methods, for example but not limited to, centrifugally casting or gravity moulding.

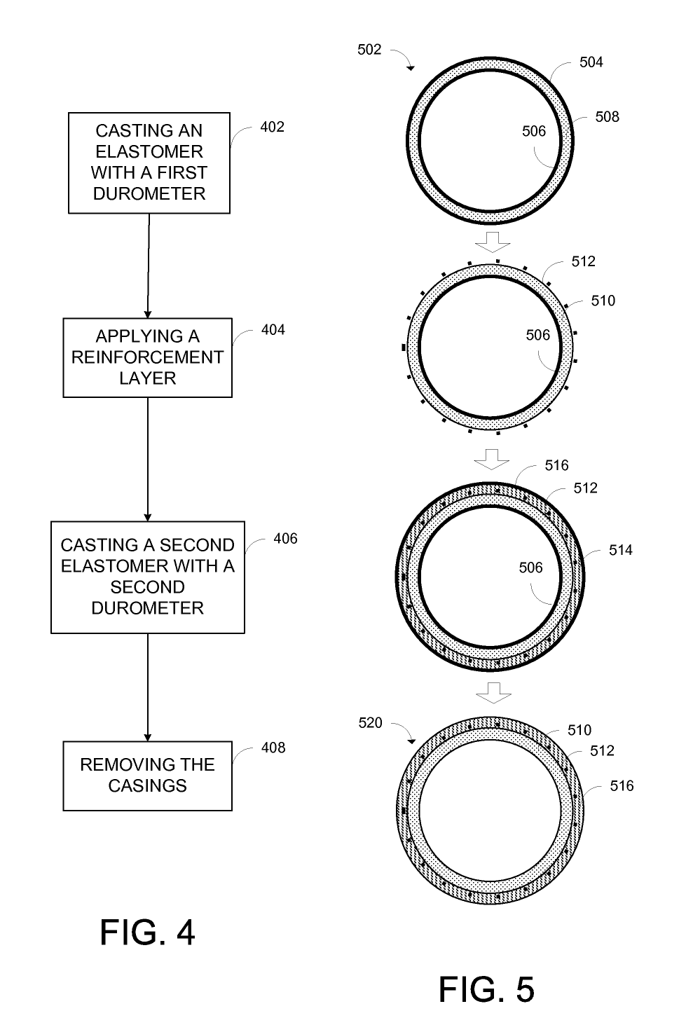

Referring to FIGS. 4 and 5, an example of manufacturing a transport belt with multiple durometers using gravity moulding is illustrated.

A mould 502 with an inner circumference corresponding to the circumference of the endless transport belt is provided. The mould 502 includes an outer casing 504 and an inner casing 506. An elastomeric material 508 having a first durometer of hardness, for example but not limited to, a polyurethane elastomer or a urethane rubber is poured 402 into the mould 502. The outer casing 504 of the mould 502 is removed after the elastomeric material 508 having the first durometer of hardness is polymerized, resulting in a first portion 510 of the transport belt with a first durometer of hardness. Optionally, a fabric or yarn reinforcement layer 512 may be applied 404 to the exterior of the first portion. A second outer casing 514 is then provided to the mould 502, providing space for a second elastomeric material 516 having a second durometer of hardness. Once the second elastomeric material 516 is casted 406 and polymerized 408, a transport belt 520 with the first or lower portion 510 with the first durometer of hardness, the second or upper portion 516 with the second durometer of hardness, and optionally, a fabric or yarn reinforcement layer 512 is formed.

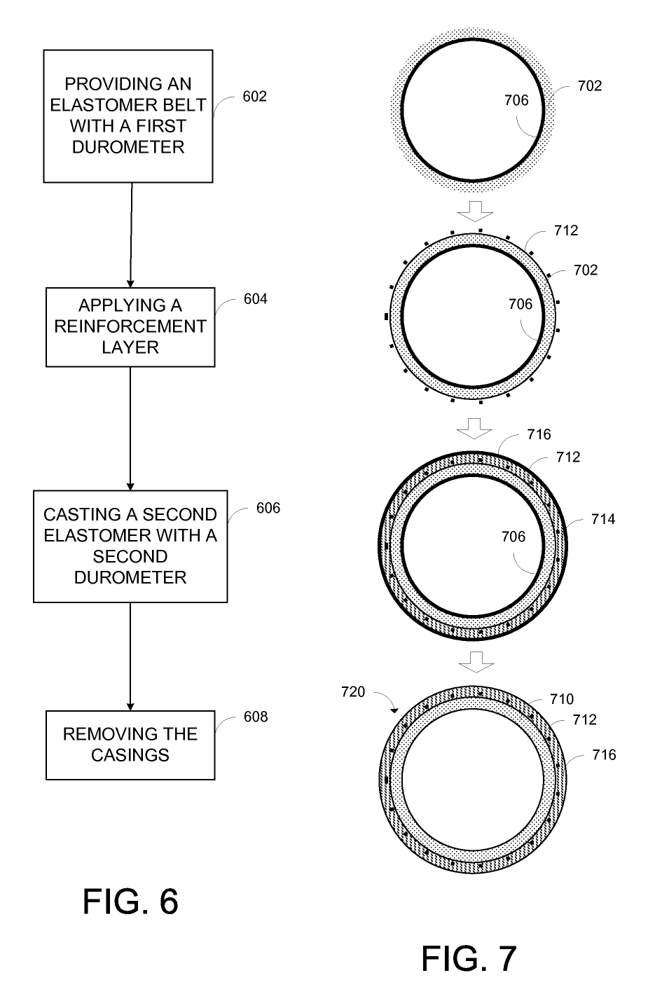

Referring to FIGS. 6 and 7, another example of manufacturing a transport belt with multiple durometers using gravity moulding is illustrated.

An elastomeric belt 702 having a first durometer of hardness, for example but not limited to, a polyurethane elastomer or a urethane rubber is provided 602. The elastomeric belt may be precast. A form 706 may optionally be used to provide support for the elastomeric belt 702, whose circumference corresponds to the inner circumference of the elastomeric belt 702.

Optionally, a fabric or yarn reinforcement layer 712 may be applied 604 to the exterior of the elastomeric belt 702.

A outer casing 714 is then provided, providing space for a second elastomeric material 516 having a second durometer of hardness. Once the second elastomeric material 716 is casted 606 and polymerized 608, a transport belt 720 with the first or lower portion 710 with the first durometer of hardness, the second or upper portion 712 with the second durometer of hardness, and optionally, a fabric or yarn reinforcement layer 712 is formed.

The present invention has been described with regard to one or more embodiments. However, it will be apparent to persons skilled in the art that a number of variations and modifications can be made without departing from the scope of the invention as defined in the claim.

What is claimed is:

1. A transport belt for a food processing machine, the transport belt comprising:
a first portion providing a surface for food materials to be processed, the first portion comprising a first elastomeric material having a first durometer of hardness; and
a second portion comprising a second elastomeric material having a second durometer of hardness;
wherein the first durometer of hardness is different than the second durometer of hardness.

2. The transport belt according to claim 1, further comprising a reinforcement material.

3. The transport belt according to claim 2, wherein the reinforcement material is located between the first portion and the second portion.

4. The transport belt according to claim 1, wherein the first durometer of hardness is higher than the second durometer of hardness.

5. The transport belt according to claim 1, wherein the first elastomeric material or the second elastomeric material is polyurethane elastomer.

6. The transport belt according to claim 1, wherein the first portion provides a ridging or a knurling.

7. The transport belt according to claim 1, wherein the first durometer of hardness is from about 70 to about 90 Shore A, preferably, from about 75 to about 85 Shore A, more preferably, about 80 Shore A.

8. The transport belt according to claim 1, wherein the second durometer of hardness is from about 50 to about 70 Shore A, preferably, from about 55 to about 65 Shore A, more preferably, about 60 Shore A.

9. The transport belt according to claim 1, wherein the second elastomeric material with the second durometer of hardness provides a better friction to a drive of the food processing machine.

10. The transport belt according to claim 2, wherein the reinforcement material is tensile-stress-bearing.

11. The transport belt according to claim 2, wherein the reinforcement material is selected from the group consisting of: canvas, crimped fabric, leno weave, and knit.

12. The transport belt according to claim 2, wherein the reinforcement material is made of any desired fiber selected from the group consisting of: aramid, nylon, polyester, rayon, Kynar, polypropylene, cotton and a combination thereof.

13. The transport belt according to claim 1, wherein the first region has a greater thickness in a center than on an edge of the transport belt.

14. A method for producing a transport belt for a food processing machine, the method comprising the steps of:
providing a mould comprising an inner casing and a first outer casing;
casting a first elastomeric material having a first durometer of hardness in to the mould;
removing the first outer casing;
providing a second outer casing in concentric relationship to the inner casing, the second outer casing having a greater diameter than a diameter of the first outer casing; and
casting a second elastomeric material having a second durometer of hardness in to the mould.

15. The method according to claim 14, further comprising the step of:
applying a reinforcement layer to the first elastomeric material after removing the first outer casing.

16. A method for producing a transport belt for a food processing machine, the method comprising the steps of:
providing a precast belt with a first elastomeric material having a first durometer of hardness in to the mould;
providing an outer casing in concentric relationship to the precast belt, the outer casing having a greater diameter than a diameter of the precast belt; and
casting a second elastomeric material having a second durometer of hardness in to the mould.

17. The method according to claim 16, further comprising the step of:
applying a reinforcement layer to the precast belt.

18. The method according to claim 16, further comprising the step of:
providing a support for the precast belt.
